(19) United States
(12) Patent Application Publication
(10) Pub. No.: US 2011/0282608 A1
(43) Pub. Date: Nov. 17, 2011

(54) PORTABLE DEFENSIVE AC IMPEDANCE DATA LOGGING DEVICE

(75) Inventor: Tony-Sheng LIN, Taipei (TW)

(73) Assignee: Tony-Sheng LIN, New Taipei City (TW)

(21) Appl. No.: 13/107,185

(22) Filed: May 13, 2011

(30) Foreign Application Priority Data
May 14, 2010 (TW) 099115596

(51) Int. Cl. G06F 19/00

(52) U.S. Cl. 702/65

(57) ABSTRACT

A portable defensive AC impedance data logging device is used for measuring the AC impedance. The portable defensive AC impedance data logging device disclosed in the present invention can display not only a traditional measured result but also a comparison result derived from the measured result and preset limit values for further producing a “near-fail” preventive result. A set of informative logging data, such as location code and date and time when the measurement is performed, is automatically added into each measured record that can be stored paperlessly in device memory for quick check. The device further combines a portable mass data storage technique to provide an unlimited automatic data storage space for convenient transporting of the measured records to other sophisticated data processing system such as personal computers.

### CROSS-REFERENCE TO RELATED APPLICATIONS

This Non-provisional application claims priority under 35 U.S.C. §119(a) on Patent Application No(s). 099115596 filed in Taiwan, Republic of China, May 14, 2010, the entire contents of which are hereby incorporated by reference.

### FIELD OF THE INVENTION

This invention relates to a portable defensive AC impedance data logging device, especially relates to a logging being capable of producing a “near-fail” preventive result and automatically adding every measured record into device memory without paper, and the measured record comprises important informative logging data such as location code and date and time when the measurement is performed. The present invention is used for improving practicability of the measured value of the AC impedance, and further, a simple and clear compared result that may contain a “near-fail” preventive result will be produced by comparing the measured value with a set of preset high and low limits, in the meanwhile, a set of informative logging data is automatically added into each measured record, and every measured record can be stored paperlessly in device memory. The device further combines with a portable mass data storage technique to provide an unlimited automatic data storage space for improving the efficiency of logging the measured impedance data.

### BACKGROUND OF THE INVENTION

In the real life environment, there are many alternative electronic signals both in a regular factory and in a field maintenance area. For example: the instrument with very sensitive and accurate electronic circuit, the ground system of the factory, or the automatic electro-mechanical production system. In many cases, we need to measure the partial or whole impedance of these AC signals. In the field of the electronic instrumentation measurement application, the measurement of the resistance or impedance is usually conducted by using an Ohm-meter. Most of traditional Ohm-meters are used to measure only the DC resistance of a resistor and are not able to measure the AC impedance. It is necessary to use an AC meter to measure both the DC resistance and the correct capacitive reactance and inductive reactance that will appear in an AC environment. The measurement result of the impedance normally is a plain single value. The interpretation and recording of the measured data is done manually in a traditional way. It is commonly seen in real applications that the in-time understanding and reaction on some critical measured data is ignored or the important data is recorded incorrectly by human mistakes. All these usually will then turn into great inconvenience or serious consequences in related applications. Therefore, it is crucial and desirable to provide a flexible and efficient measurement method and device to display and record the measured impedance in many practical applications in modern life.

In real applications today, many impedance sources may need measurement and the result usually ends up with a huge amount of data to be recorded manually. Unfortunately, such writing or recording may not be easy to perform due to the physical limitations at site of measurement, such as lack of sufficient light or paper on site when measurement is performed. How to accurately record and safely store the measured data becomes an important issue in many industries today without available good solutions. In applications where frequent measurement in a wide area for a large number of measurement points is required, the volume of measured data will be huge. The situation in such case will become worse and may simply go out of control.

### SUMMARY OF THE INVENTION

The present invention is used to solve the disadvantages existed in the prior art. Therefore, the present invention discloses a portable defensive AC impedance data logging device, especially relates to a logging being capable of producing a “near-fail” preventive result and automatically adding every measured record into device memory without paper, and the measured record comprises important informative logging data such as location code and data and time when the measurement is performed. The storage and analysis of the measured result of the AC impedance is further manipulated by the logging device, and every measured record can be stored paperlessly in device memory and a portable mass data storage device for providing an unlimited automatic data storage space. The present invention can satisfy different needs under various environments and improve the efficiency of measuring the AC impedance data logging to reduce the total cost.

The present invention discloses a portable defensive AC impedance data logging device for achieving the abovementioned purpose. The portable defensive AC impedance data logging device comprises a keyboard input unit 1, an AC impedance pre-measured unit 2, a specific functional processing unit 3, a storage management unit 4, a display unit 5, a communication unit 6 and a power supply management unit 7. The keyboard input unit 1 is used for manual setting of the logging device and quickly operating of storing the measured records. The keyboard input unit 1 comprises a set of numeral keys, a set of editing keys including several “quick” special functional keys. The AC impedance pre-measured unit 2 is used for measuring an analog signal of the AC impedance, and the analog signal is preprocessed and translated to a digital signal. After translating, the AC impedance pre-measured unit 2 sends the digital signal to the specific functional processing unit 3 for further digital processing. The specific functional processing unit 3 is responsible for totally calculating measured results and controlling the portable defensive AC impedance data logging device. Furthermore, the specific functional processing unit 3 performs a storage management, supports the hotkey instructions and performs a management of an online menu through a LCD. The storage management unit 4 manages a flash memory and a portable mass data storage device, and the portable mass storage device can be a SD memory card used in a personal computer. A user can exchange a new and empty storage device to achieve an unlimited data storage effect when the portable mass data storage device is full of data. The display unit 5 is used for displaying the measured results immediately and the operating status of the portable defensive AC impedance data logging device through a LCD/LED. The communication unit 6 is used for providing a communication interface between the specific functional processing unit 3 and a personal computer for the user to perform the verification and the maintenance of hardware control parameters stored in the specific functional processing unit 3 through a management software on the personal computer. The power supply management unit 7 is responsible for the battery charging management to provide the portable defensive AC impedance data logging device with power.

Please refer to FIGS. 1-5, the features and advantages of the present invention will be understood from the following illustration.

### BRIEF DESCRIPTION OF THE DRAWINGS

FIG. 1 illustrates a block diagram of the system disclosed in the present invention;

FIG. 2 shows an arrangement of keys disclosed in the present invention;

FIG. 3 shows a measured result displayed by a LCD according to the present invention;

FIG. 4 shows the operating steps disclosed in the present invention; and

FIG. 5 shows the device disclosed in the present diagram.

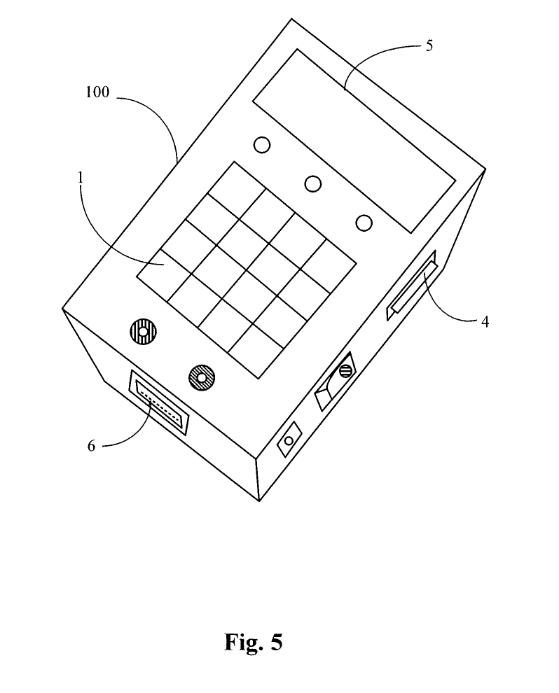

### DETAILED DESCRIPTION OF THE INVENTION

According to the method and device disclosed in the present invention, a preferred embodiment will be illustrated along with the figures as the following.

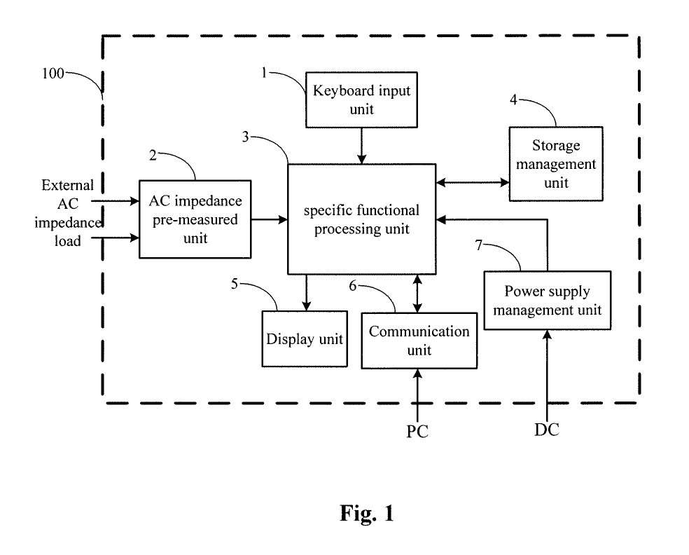

Please refer to FIG. 1. FIG. 1 illustrates a block diagram of the portable defensive AC impedance data logging device disclosed in the present invention. The portable defensive AC impedance data logging device comprises components described as follows:

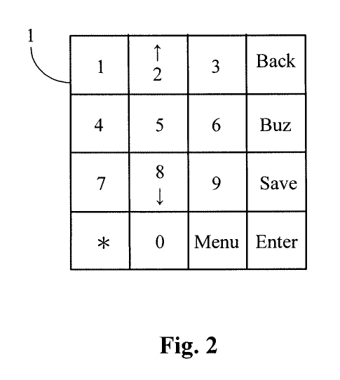

Please refer to FIG. 2, a keyboard input unit 1 comprises numeral keys from zero to nine, an editing key (such as input key “ENTER” and delete key “BACK”) and several “quick” specific functional keys (such as storage key “SAVE” and alarm key “BUZ ON/OFF”). The keyboard input unit 1 is used for providing a simple tool to perform a manual setting of the logging device and a quick operation during a storage process of the measured record.

An AC impedance pre-measured unit 2 possesses a pair of input wires that form a closed circuit loop with an input loading to be measured, sensing an analog signal of the AC impedance on the closed circuit being measured by a measurement circuit. The analog current signal is converted and amplified to a voltage signal, and translated to a digital signal. After translating, the digital signal will be sent to a specific functional processing unit 3 for further processing.

The specific functional processing unit 3 is a core processor of the portable defensive AC impedance data logging device and is used for calculation of the measured results and management controlling of the device disclosed in the present invention. The specific functional processing unit 3 receives the digital signal from the AC impedance pre-measured unit 2 and automatically switches to a suitable voltage range according to the magnitude of the actual measured value so that a correct digital measured impedance value will be calculated for determining a final measured result. Furthermore, the specific functional processing unit 3 performs a storage management of combining a logging data and the measured result according to a preset format and sends them to a storage management unit 4 after combining. The logging data comprises other information including an operator, a measured location, a measured date and a measured time. On the other hand, the specific functional processing unit 3 also receives a hotkey instruction from the keyboard input unit I and handles the specific function of the hotkey instruction. The specific functional processing unit 3 further performs a management of an online menu through a display unit 5—LCD for example. The controlling items of the online menu include the setting of the upper limit value and the lower limit value for determining if the measured results are OK or not, the setting of a “near-fail” limit range of the upper limit value and the lower limit value, the setting of codes for a logging location and a logging operator, and the setting of date and time of the system.

The storage management unit 4 receives the data of combining the logging data and the measured result from the AC impedance pre-measured unit 2 and puts them into a flash memory and a portable mass storage device, separately. The portable mass storage device can be a SD memory card used in a personal computer. The user can perform an online inquiry of measured records by accessing the contents of the flash memory. The user can further exchange a new and empty storage device to achieve an unlimited data storage effect when the portable mass data storage device is full of data. The storage management unit 4 further comprises a real time clock circuit for providing a built-in date and time of the logging device disclosed in the present invention.

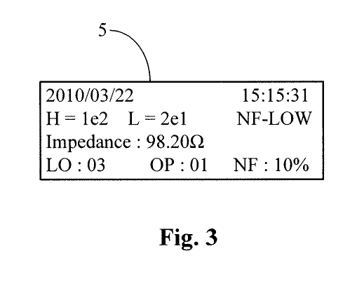

The display unit 5 can be a group consisting of a LCD, a LED and a buzzer. Please refer to FIG. 3, the display unit 5 can be used for displaying the measured results immediately and the operating status of the portable defensive AC impedance data logging device through a LCD/LED. Furthermore, LCD also displays the measured record of the online inquiry. The buzzer will alarm when the measured value is larger than a preset limit value.

A communication unit 6 is used for providing a communication interface between the specific functional processing unit 3 and a personal computer. The user can perform the verification and the maintenance of hardware control parameters through a management software on the personal computer.

A power supply management unit 7 is responsible for the battery charging management to provide the portable defensive AC impedance data logging device with power.

The final measured data can be selected from a group consisting of the following five results:

(1) Fail-High: the final measured result is over the preset upper-limit value;

(2) Near-High OK: the final measured result is near the preset upper-limit value, but is still acceptable;

(3) OK: the final measured result is between preset upper-limit and lower-limit values;

(4) Near-Low OK: the final measured result is near the preset lower-limit value, but is still acceptable; and

(5) Fail-Low: the final measured result is lower than the preset lower-limit value.

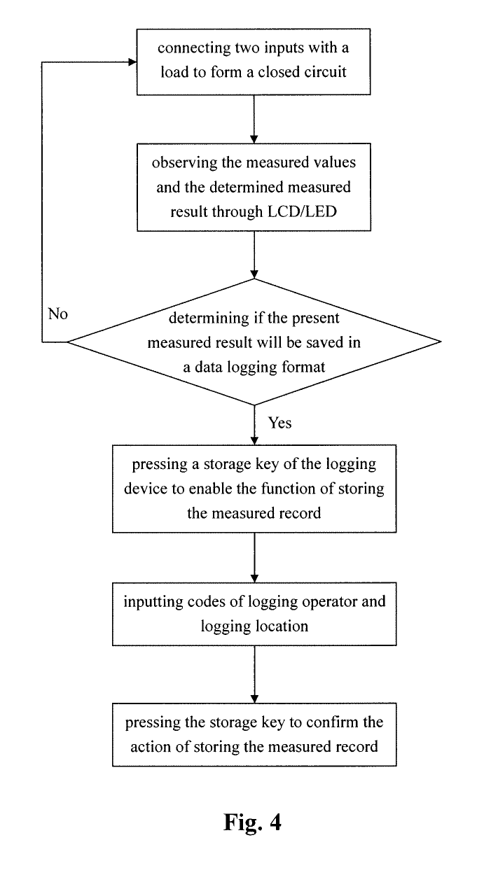

Please refer to FIG. 4. FIG. 4 shows the operating steps according to an embodiment of the present invention. The power of the logging device disclosed here will be turned on first. And then, the operating steps comprise:

(1) connecting two inputs with a load to form a closed circuit;

(2) observing the measured values and the determined measured result through LCD/LED;

(3) determining if the present measured result will be saved in a data logging format;

(4) if not, repeating the step 1; if yes, pressing the storage key of the logging device to enable the function of storing the measured record and continue to next step;

(5) inputting codes of logging operator and logging location;

(6) pressing the storage key to confirm the action of storing the measured record.

According to the abovementioned, the portable defensive AC impedance data logging device has advantages of high mobility, high efficiency and high practicability for achieving the highest benefits of measuring the AC impedance. The abovementioned benefits comprise: (1) the measured result will be interpreted immediately, that is, the measured result is OK or NG compared with the preset upper-limit value and lower-limit value; (2) a preventive alarm will occur when the measured result is near the preset limit value, that is, the result of comparing between the measured result and the preset upper-limit/lower-limit value is Near-High OK or Near-Low OK; (3) other informative logging data, such as operator code, location code, date and time, is automatically added into the measured result to increase the practicability of the measured record; (4) the measured record is stored paperlessly for reduced cost; (5) a portable mass data storage device is used for storing the measured records to improve data transporting and handling efficiency.

This present invention is suitable for many applications. For example: SMT process restricted area, military and national defense static control area, semiconductor clean room, high-tech lab, aviation and aero maintenance area, hospital restricted area, medical static restricted area, bio-chemistry static control area and explosives disposal area.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A portable defensive AC impedance data logging device, comprising:
an AC impedance pre-measured unit possessing a pair of input wires that form a closed circuit loop with an input loading to be measured, sensing an analog signal of the AC impedance on the closed circuit being measured and preprocessing the analog signal into digital signal;
a specific functional processing unit being responsible for calculating measured results and overall controlling the portable defensive AC impedance data logging device, receiving a preprocessed signal from the AC impedance pre-measured unit to calculate a correct digital value and determining a final measured result, performing a storage management of combining informative logging data and the final measured result, handling hotkey instructions of a keyboard input unit and connecting with a display unit for performing a management of an online menu;
a storage management unit connecting with the specific functional processing unit for managing a portable mass storage device for the recording and storage of the measured data;
the keyboard input unit connecting with the specific functional processing unit to provide a user a simple and quick tool for setting and operating of the portable defensive AC impedance data logging device; and
the display unit connecting with the specific functional processing unit for displaying the measured results immediately and the operating status of the portable defensive AC impedance data logging device.

2. The device according to claim 1, further comprising:
a communication unit providing a communication interface between the specific functional processing unit and a personal computer for a user to perform the verification and the maintenance of hardware control parameters stored in the specific functional processing unit through a management software on the personal computer.

3. The device according to claim 1, further comprising:
a power supply management unit being responsible for the battery charging management to provide the portable defensive AC impedance data logging device with power.

4. The device according to claim 1, wherein the preprocess performed by the AC impedance pre-measured unit is to amplify and convert the analog current signal to a voltage signal and transform the analog signal to a digital signal.

5. The device according to claim 1, wherein the determining of final measured result by the specific functional processing unit is performed by comparing the measured result with a preset upper-limit value and a preset lower-limit value.

6. The device according to claim 5, wherein the final measured result can be selected from a group consisting of the following five results: OK, Near-High OK, Near-Low OK, Fail-High and Fail-Low.

7. The device according to claim 1, wherein the informative logging data comprises information of an operator who did the measurement, the location where the measurement is performed, and the date and time when the measurement is performed.

8. The device according to claim 1, wherein the hotkey instructions of the keyboard input unit include a numeral key, an editing key and several specific functional keys.

9. The device according to claim 1, wherein the management of the online menu include the setting of the upper limit value and the lower limit value for determining if the measured data is OK or not, the setting of a “near-fail” limit range of the upper limit value and the lower limit value, the setting of codes of a logging location and a logging operator, and the setting of date and time of the system.

10. The device according to claim 1, wherein the portable mass storage device can be a SD memory card usually used in the personal computer, and the stored data can be transported to other data processing device via the SD memory card for further processing.
